(19) United States
(12) Patent Application Publication
(10) Pub. No.: US 2005/0188616 A1
(43) Pub. Date: Sep. 1, 2005

(54) Fuel processing treatment system and fuel processing systems containing the same

(76) Inventors: Travis A. Bizjak, Bend, OR (US); David J. Edlund, Bend, OR (US); William A. Pledger, Sisters, OR (US)

Correspondence Address: KOLISCH HARTWELL, P.C., 520 S.W. YAMHILL STREET, SUITE 200, PORTLAND, OR, 97204, US

(21) Appl. No.: 10/789,754

(22) Filed: Feb. 27, 2004

(51) Int. Cl. B01J 7/00

(52) U.S. Cl. 48/127.9; 48/61

(57) ABSTRACT

Fuel processing systems, which contain a fuel processor, and feedstock treatment systems for use in the same. The fuel processor is configured to produce a hydrogen, or hydrogen-rich, stream from a feed stream, which may include, for example, at least one carbon-containing feedstock and/or water. At least a portion of the feed stream is a vaporized feed stream. The fuel processing system further includes a treatment region configured to remove solids from at least the vaporized component of the feed stream prior to production of hydrogen gas from the feed stream. In some embodiments, a common housing at least substantially encloses one or more regions of the fuel processing system, and in some embodiments one or more of those regions are accessible from external the common housing without disassembling that housing.

### FIELD OF THE DISCLOSURE

The present disclosure is directed generally to fuel processing systems, which contain a fuel processor configured to produce hydrogen gas, and more particularly to treatment systems for use in fuel processing systems.

### BACKGROUND OF THE DISCLOSURE

Fuel processing systems include a fuel processor that produces hydrogen, or hydrogen-rich, gas from at least one feedstock, such as a carbon-containing feedstock and/or water. The feedstock may be vaporized prior to formation of the hydrogen, or hydrogen rich, gas in the fuel processor. That vaporization may lead to changes in the chemical and/or physical characteristics of the feedstock that may cause operational and/or safety problems in the fuel processor. For example, vaporization of water may produce solids, such as colloidal silica and any impurities that are reduced to solid form upon vaporization of the liquid water. As another example, vaporization of a carbon-containing feedstock may result in the formation of coke or other carbon-containing solids. The solids may accumulate within the conduits through which the feedstocks flow and/or coat the catalysts used to produce hydrogen gas from the feedstocks. This increase in solids may also cause an increase in the pressure drop in the fuel processor or conduits within the fuel processing system between the vaporization region and the hydrogen-producing region of the fuel processor.

### SUMMARY OF THE DISCLOSURE

The present disclosure is directed to fuel processing systems, which contain a fuel processor, and to feedstock treatment systems for use in the same. The fuel processor is configured to produce a hydrogen, or hydrogen-rich, stream from a feed stream, which may include, for example, at least one carbon-containing feedstock and/or water. At least a portion of the feed stream is a vaporized feed stream. The fuel processing system further includes a treatment region configured to remove solids from at least the vaporized component of the feed stream prior to production of hydrogen gas from the feed stream. In some embodiments, a common housing at least substantially encloses one or more regions of the fuel processing system, and in some embodiments one or more of those regions are accessible from external the common housing without disassembling that housing.

### BRIEF DESCRIPTION OF THE DRAWINGS

FIG. 1 is a schematic diagram of a fuel processing system according to the present disclosure.

FIG. 2 is a schematic diagram of another fuel processing system according to the present disclosure.

FIGS. 3-5 are schematic diagrams illustrating flow variations associated with the vaporization region of the fuel processing system of FIG. 1.

FIG. 6 is a schematic diagram of a suitable filter for use in the fuel processing system of FIG. 1.

FIG. 7 is a schematic diagram of another embodiment of the fuel processing system of FIG. 1.

FIG. 8 is a schematic diagram of another embodiment of the fuel processing system of FIG. 1.

FIG. 9 is a schematic diagram of another embodiment of the fuel processing system of FIG. 1.

FIG. 10 is a schematic diagram of a fuel cell system containing a fuel processing system with a fuel processor and a treatment system according to the present disclosure.

### DETAILED DESCRIPTION AND BEST MODE OF THE DISCLOSURE

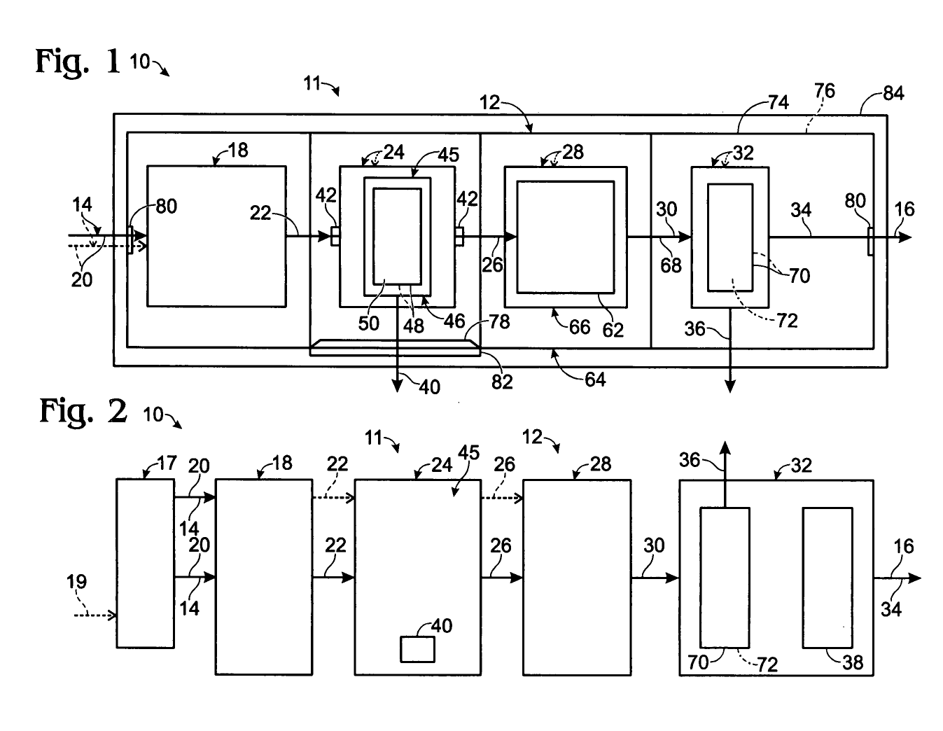

A fuel processing system 10 is schematically illustrated in FIG. 1. System 10 includes a fuel processing assembly 11 that is configured to receive at least one feed stream 14 and to produce a product hydrogen stream 16 that contains at least substantially pure hydrogen gas. Fuel processing assembly 11 includes at least one fuel processor 12 and at least one of the subsequently described treatment regions 24. Fuel processor 12 includes at least one hydrogen-producing region 28 that is configured to receive feed stream 14 and to produce therefrom a mixed gas stream 30, which contains hydrogen gas as at least a primary component and which typically contains a minor amount of one or more other gases. As discussed in more detail herein, the fuel processing assembly and/or fuel processing system may include at least one separation region, or separation assembly, 32 that is adapted to increase the purity of the hydrogen gas present in the mixed gas stream and/or to remove or reduce the concentration of one or more of the other gases in the mixed gas stream.

Before describing in more detail fuel processing systems according to the present disclosure, the feed streams 14 for these systems will be first described. The one or more feed streams 14 contain the reactants, or feedstocks, that are consumed to form hydrogen gas in hydrogen-producing region 28. For example, the one or more feed streams typically will include at least water and/or a carbon-containing feedstock. Examples of suitable carbon-containing feedstocks include one or more alcohols and/or hydrocarbons. Nonexclusive examples of suitable alcohols include methanol, ethanol, and polyols, such as ethylene glycol and propylene glycol. Nonexclusive examples of suitable hydrocarbons include methane, propane, natural gas, diesel, kerosene, gasoline and the like.

When a feed stream contains more than one feedstock, the feedstocks may be delivered to the fuel processor and/or a hydrogen-producing region thereof as separate feed streams or as a single feed stream. Similarly, when the feedstocks are mixed together prior to delivery to the fuel processor or a hydrogen-producing region thereof, the mixture of feedstocks may be delivered in one or more feed streams, even though the composition of these streams may be the same, or at least very similar. As used herein, the term “feed stream” is used generally to refer to one or more fluid streams that contain at least one feedstock for the fuel processor's hydrogen-producing region. For example, fuel processing system 10 may contain a feed stream 14 containing one or more feedstocks and which is physically delivered to the fuel processor in any suitable number of fluid conduits.

Regardless of the composition and number of feedstocks in the one or more feed streams and the number of discrete streams delivered to a hydrogen-producing region, at least one feed stream 14 according to the present disclosure will include at least one feedstock or component that is received in liquid form and subsequently vaporized prior to being consumed as a reactant to form hydrogen-gas in a hydrogen-producing region of the fuel processor. For example, a component of a feed stream may be delivered to the fuel processing system, to the fuel processing assembly, and/or to the fuel processor in liquid form and then vaporized prior to being consumed to form hydrogen gas. As a more specific example, water may be delivered in liquid form and then vaporized to form steam, or even superheated steam, prior to being used to form hydrogen gas in hydrogen-producing region 28. As another example, a carbon-containing feedstock may be normally stored as a liquid, but vaporized prior to being used to form hydrogen gas in hydrogen-producing region 28.

It is not required that the entire feed stream, or all of the feedstocks, be delivered in liquid form and thereafter vaporized prior to being used to form hydrogen gas. For example, at least a portion of the feed stream may be gaseous, or in gas form, when delivered to the fuel processing system and/or when consumed to form hydrogen gas. As used herein, feed stream 14 may be described as containing a liquid component 20, with this liquid component being vaporized to form a vaporized component 22 prior to being used to form hydrogen gas in hydrogen-producing region 28. As used herein, the liquid and vaporized components of feed stream 14 also may be described as liquid feed stream components and vaporized feed stream components.

Feed stream 14 is typically delivered to the fuel processing assembly by a suitable feed stream delivery system, such as schematically illustrated at 17 in FIG. 2. Delivery system 17 includes any suitable mechanism, device, or combination thereof that delivers the feed stream to the fuel processing assembly, such as from one or more supplies that form a portion of the fuel processing system or from external supplies that are at least selectively in communication with the fuel processing system. For example, the delivery system may include one or more pumps that deliver the components of stream 14 from one or more supplies. Additionally, or alternatively, system 17 may include a valve assembly configured to regulate the flow of the components from a pressurized supply, such as indicated in dashed lines at 19. The supplies may be located external of the fuel processing system, or may be contained within or adjacent the system.

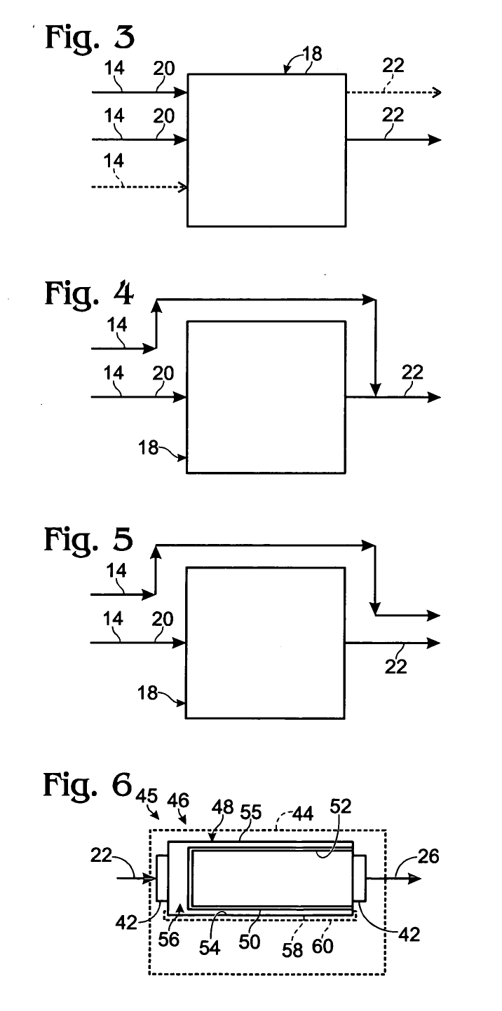

Fuel processing system 10 and/or fuel processing assembly 11 may include a vaporization region 18 that is configured to receive at least liquid component 20 of feed stream 14 and to produce vaporized component 22 therefrom. Additionally or alternatively, the fuel processing assembly may be adapted to receive at least one vaporized component 22 of the feed stream, such as a component that was vaporized prior to delivery to fuel processing assembly 11. Vaporization region 18 may utilize any suitable vaporization structure to vaporize at least liquid component 20 of feed stream 14 to form vaporized component 22. Although only liquid component 20 and vaporized component 22 of feed stream 14 have been schematically illustrated in FIG. 1, it is within the scope of the disclosure that vaporization region 18 receives more than one liquid component of feed stream 14 and/or produces more than one vaporized component, as schematically illustrated in FIG. 3. Vaporization region 18 may receive separate streams, such as when feed stream 14 contains immiscible components, such as water and a carbon-containing feedstock. In such a configuration, either or both of the component streams may be vaporized in region 18. An example of such a configuration is schematically illustrated in FIG. 2. As indicated in dashed lines, the vaporized streams may be mixed in, or downstream from, vaporization region 18. When feed stream 14 contains miscible components, such as water and an alcohol or other water-soluble carbon-containing feedstock, vaporization region 18 may (but is not required to) receive a single stream containing the miscible components.

Additionally, one or more components of feed stream 14 may bypass vaporization region 18 and combine with vaporized component 22 downstream from that region as schematically illustrated in FIG. 4. Furthermore, one or more components of feed stream 14 may bypass vaporization region 18 and enter the subsequently described treatment region 24 separate from vaporized component 22 as schematically illustrated in FIG. 4. The bypass shown in FIGS. 4 and 5 may be used when one or more components of feed stream 14 already are vaporized or in gaseous form. Other flow variations associated with vaporization region 18 may be used. Although flow variations for only vaporization region 18 have been discussed and illustrated, it is within the scope of this disclosure that at least the same flow variations are associated with the subsequently described treatment region 24.

Any suitable mechanism and/or structure may be used to vaporize the liquid component of feed stream 14 to form vaporized component 22. For example, the vaporization region may include a burner or other heating assembly that is adapted to produce the heat required to vaporize the liquid feed stream component. As another example, the vaporization region may vaporize the liquid feed stream component by heat exchange with a heated fluid stream and/or conduction/convection of heat from a hotter component of the fuel processing system. For example, a liquid component of a carbon-containing feedstock may be vaporized by heat exchange and/or mixing with steam, or even superheated steam. It is within the scope of the disclosure that this steam also may form a water component of the feed stream 14. As another example, a heated exhaust stream from the fuel processing system may be used to vaporize the liquid feed stream component. As a further example, many hydrogen-producing regions are operated at elevated temperatures, such as may be obtained by a suitable burner or heating assembly, and the vaporization region may be in thermal communication with the hydrogen-producing or other heated region to receive the required heat to vaporize the liquid feed stream component. In such a configuration, it may be desirable for the vaporization region to take the form of one or more fluid conduits that extend through this heated region, around the exterior of this region, or along the exterior of this region. As yet another example, some hydrogen-producing regions are heated by exothermic reactions that are used to produce hydrogen gas, and the region may be cooled by being used to vaporize at least a liquid component of the feed stream, such as via suitable heat exchange conduits and/or mechanisms.

Fuel processing assembly 11 also includes at least one treatment region 24 that is configured to receive at least vaporized component 22 of feed stream 14 and to produce a treated component, or treated feed stream component, 26 therefrom. Treatment region 24 may be described as being adapted to remove solids from at least the vaporized feed stream component. It is within the scope of the present disclosure that both gaseous and vaporized feed stream components may be passed through the treatment region, and that the fuel processing system may include more than one treatment region. When the fuel processing system includes more than one treatment region, the regions may be arranged in series to treat the same stream, in parallel to treat portions of streams having the same or very similar compositions, and/or in parallel to separately treat different compositional portions of the feed stream.

In embodiments of fuel processing system 10 that include a vaporization region 18 that receives and vaporizes a liquid feed stream component, treatment region 24 is in fluid communication with vaporization region 18 and hydrogen-producing region 28. In embodiments of a fuel processing system that receives a vaporized feed stream component from external the fuel processing system, the treatment region is adapted to receive this component and is upstream and in fluid communication with the hydrogen-producing region. By “fluid communication,” it is meant that fluid (such as a liquid or gas, as appropriate) can flow between the respective elements that are in fluid communication with each other.

Treatment region 24 may utilize any suitable treatment structure 45 that is adapted to remove solids 40 from the portion of feed stream 14 that flows through the treatment region. Although solids 40 are schematically illustrated in FIG. 1 as “flowing” from treatment region 24, it should be understood that, in many cases, solids 40 do not flow. Instead, solids 40 typically will be collected and retained in treatment region 24 until removed. This is schematically illustrated in FIG. 2. In some embodiments, liquid component 20 of feed stream 14 will be at least substantially, or even completely, free of solids 40 before vaporization region 18. In other words, the vaporized feed stream component may include more solids than the liquid feed stream component from which it was formed. This is because a substantial portion of solids 40 may be (but are not required to be) formed in vaporization region 18. In some embodiments, solids 40 may include colloidal silica and/or carbon-containing solids, particularly when feed stream 14 consists of water and a carbon-containing feedstock. Solids 40 may include such forms as scale and particulate that are formed during the vaporization process.

An illustrative, but not exclusive, example of a suitable treatment structure 45 is a filter assembly 46, such as schematically illustrated in FIG. 1. Filter assembly 46 is configured to remove solids from the portion of feed stream 14 that passes therethrough. Filter assembly 46 includes at least one filter 48, such as shown schematically in FIG. 1, and may include more than one filter without departing from the scope of the present disclosure. Any suitable filter media or structure 50 may be used for filter 48. Examples include sintered filter element(s) or other structures, porous ceramic materials, woven or non-woven metal mesh or screens, and the like. The filter media and/or structure should be selected to be thermally and chemically stable when exposed to vaporized components of feed stream 14. In FIG. 6, a less schematic example of a suitable, but by no means exclusive, structure for filter 48 is shown. As shown, filter 48 includes an inside diameter 52 and an outside diameter 54. Filter 48 may be configured so that vaporized components of feed stream 14 flow from the outside diameter to the inside diameter, or vice-versa. The former flow configuration may provide operational advantages, such as increasing the available surface area of filter 48. However, any suitable filter structure and/or flow configuration may be used.

Treatment region 24 may be secured to other components and/or regions of fuel processor 12 by any suitable fastening mechanisms 42. Examples of suitable fastening mechanisms include permanent fastening mechanisms and releasable fastening mechanisms. “Permanent fastening mechanisms,” refers to mechanisms such as adhesives and welds that cannot be released without destruction of at least the fastening mechanism. On the other hand, “releasable fastening mechanisms,” refers to releasable couplings, bolts, clamps, and other mechanical fasteners that are designed to be repeatedly connected, disconnected, and reconnected without destruction of the fastening mechanism. Treatment region 24 may be, but is not required to be, partially or completely surrounded by an insulated shroud 44, such as a solid insulating material, blanket insulating material, and/or an air-filled, gas-filled, or vacuum cavity.

Filter 48 also may include a housing 55. Housing 55 may include one or more openings that are sufficiently large for an internal area 56 to be accessed by a user, such as for maintenance, adjustment, servicing, and/or repair, without requiring the user to disassemble filter 48. The opening may take any form, such as portals, ports, pathways, or other suitable forms. Openings in housing 55 typically will include covers associated therewith to maintain the integrity of filter 48 while in operation. An illustrative example of an opening and a cover are graphically depicted in FIG. 6 at 58 and 60, respectively. However, it is also within the scope of disclosure for the filter assembly or individual filters therein to be releasably coupled to the fuel processing system so that the filter or filter assembly can be readily removed, such as for servicing, maintenance, or repair.

Hydrogen-producing region 28 may include any suitable structure, and accordingly utilize any suitable mechanism, to produce mixed gas stream 30 from feed stream 14. For example, electrolysis is a hydrogen-producing process in which hydrogen gas and oxygen gas are produced from water. Other types of suitable hydrogen-producing mechanisms, such as partial oxidation and pyrolysis, utilize a feed stream consisting of a carbon-containing feedstock, such as an alcohol or a hydrocarbon, to produce the mixed gas stream. In still other mechanisms, feed stream 14 includes water and a carbon-containing feedstock.

An example of a hydrogen-producing mechanism in which feed stream 14 comprises water and a carbon-containing feedstock is steam reforming. Another is autothermal reforming. In a steam reforming process, hydrogen-producing region 28 contains a reforming catalyst 62. In such an embodiment, fuel processor 12 may be referred to as a steam reformer 64, hydrogen-producing region 28 may be referred to as a reforming region 66, and mixed gas stream 30 may be referred to as a reformate stream 68. Illustrative examples of suitable steam reforming catalysts include copper-zinc formulations of low temperature shift catalysts and a chromium formulation sold under the trade name KMA by Süid-Chemie, although others may be used. The other gases that typically are present in the reformate stream include carbon monoxide, carbon dioxide, methane, steam and/or unreacted carbon-containing feedstock.

Preferably, steam reformer 64, or any other fuel processor 12 within the scope of the present disclosure, is configured to produce substantially pure hydrogen gas, and even more preferably, pure hydrogen gas. For the purposes of the present disclosure, substantially pure hydrogen gas is greater than 90% pure, preferably greater than 95% pure, more preferably greater than 99% pure, and even more preferably greater than 99.5% pure. Examples of suitable fuel processors, fuel processing systems, vaporization regions, steam reformers and the like are disclosed in U.S. Pat. Nos. 6,221,117 and 6,319,306, and in pending U.S. patent applications Ser. Nos. 09/802,361, 10/407,500, and 10/412,709, the complete disclosures of each of which is incorporated by reference in its entirety for all purposes.

Steam reformers typically operate at temperatures in the range of 200° C. and 700° C., and at pressures in the range of 50 psi and 300 psi, although temperatures and pressures outside of this range are within the scope of the disclosure. When the carbon-containing feedstock is an alcohol, the steam reforming reaction will typically operate in a temperature range of approximately 200-500° C., and when the carbon-containing feedstock is a hydrocarbon, a temperature range of approximately 400-700° C. typically will be used for the steam reforming reaction. When the carbon-containing feedstock is a hydrocarbon, the reformer may be adapted to initially break the longer chain hydrocarbons in a “pre-reforming” region, and thereafter produce the mixed gas stream in a primary reforming region, which is typically operated at higher temperature than the pre-reforming region.

Regardless of the mechanism by which the fuel processor produces hydrogen gas, fuel processing system 10 may, but is not required to, include at least one separation region 32. Separation region 32 may also be referred to as a purification region, as it is adapted to produce a stream that has, compared to the mixed gas stream, a greater purity of hydrogen gas and/or a reduced amount of one or more other components of the mixed gas stream. Separation region 32 may utilize any suitable process, including chemical and/or physical processes. In a physical process, physical barriers are used to provide the separation of purification. In a chemical process, one or more of the non-hydrogen components of the mixed gas stream are reacted to reduce their relative concentration.

For example, when the product hydrogen stream is going to be used as a fuel stream for certain fuel cell stacks, it may be desirable to remove, or at least reduce, the concentration of carbon monoxide and carbon dioxide in the mixed gas stream. In a separation region 32 in which a physical separation process is utilized, the mixed gas stream 30 produced in the hydrogen-producing region is separated into a hydrogen-rich stream 34, which contains at least substantially pure hydrogen gas, and a byproduct stream 36, which contains at least a substantial portion of other gases. Hydrogen-rich stream 34 may additionally, or alternatively, be described as containing a higher concentration of hydrogen gas than the mixed gas stream, and/or containing a lower concentration of one or more of the other gases than the mixed gas stream. At least a substantial portion of hydrogen-rich stream 34 is typically used to form product hydrogen stream 16. When the fuel processing system does not include a separation region, the mixed gas or other product stream from the fuel processor will form the product hydrogen stream. The byproduct stream may be used as a combustible fuel, exhausted, sent to a burner, used as a heated fluid stream, stored for later use, etc. It is within the scope of the present disclosure that the byproduct stream may actually not “flow” as a fluid stream from the separation region, with the region instead being adapted to at least temporarily trap or otherwise contain the portion of the mixed gas stream that is removed in the separation region.

Separation region 32 may utilize any suitable separation structure to separate mixed gas stream 30 into hydrogen-rich stream 34 and byproduct stream 36. An example of a suitable separation structure for separation region 32 is one or more hydrogen-permeable and/or hydrogen-selective membranes, such as schematically illustrated in FIG. 1 at 70. The membranes may be formed of any hydrogen-permeable material suitable for use in the operating environment and parameters in which separation region 32 is operated. Examples of suitable materials for membranes 70 include palladium and palladium alloys, and thin films of such metals and metal alloys. Palladium alloys have proven particularly effective, especially palladium with 35 wt % to 45 wt % copper. A palladium-copper alloy that contains approximately 40 wt % copper has proven particularly effective, although other relative concentrations and components may be used within the scope of the disclosure.

Hydrogen-selective membranes are typically formed from a thin foil that is approximately 0.001 inches thick. It is within the scope of the present disclosure, however, that the membranes may be formed from other hydrogen-permeable and/or hydrogen-selective materials, including metals and metal alloys other than those discussed above, as well as non-metallic materials and compositions, and that the membranes may have thicknesses that are greater or less than discussed above. For example, the membranes may be made thinner, with commensurate increase in hydrogen flux. Examples of suitable mechanisms for reducing the thickness of the membranes include rolling, sputtering, and etching. A suitable etching process is disclosed in U.S. Pat. No. 6,152,995, the complete disclosure of which is hereby incorporated by reference for all purposes. Examples of various membranes, membrane configurations, and methods for preparing the same are disclosed in U.S. Pat. Nos. 6,221,117, 6,319,306, 6,537,352, 6,569,227, and 6,596,057, the complete disclosures of which are hereby incorporated by reference for all purposes.

Another example of a suitable process for use in separation region 32 is pressure swing adsorption, as schematically illustrated at 72 in FIG. 1 with a dash-dot line. In a pressure swing adsorption (PSA) process, gaseous impurities are removed from a stream containing hydrogen gas. PSA is based on the principle that certain gases, under the proper conditions of temperature and pressure, will be adsorbed onto an adsorbent material more strongly than other gases. Typically, the impurities are adsorbed and thus removed from mixed gas stream 30. The success of using PSA for hydrogen purification is due to the relatively strong adsorption of common impurity gases (such as CO, CO₂, hydrocarbons including CH₄, and N₂) on the adsorbent material. Hydrogen adsorbs only very weakly and so hydrogen passes through the adsorbent bed while the impurities are retained on the adsorbent material. Impurity gases such as NH₃, H₂S, and H₂O adsorb very strongly on the adsorbent material and are therefore removed from mixed gas stream 30 along with other impurities. If the adsorbent material is going to be regenerated and these impurities are present in mixed gas stream 30, separation region 32 preferably includes a suitable device that is configured to remove these impurities prior to delivery of mixed gas stream 30 to the adsorbent material because it is more difficult to desorb these impurities.

Adsorption of impurity gases occurs at elevated pressure. When the pressure is reduced, the impurities are desorbed from the adsorbent material, thus regenerating the adsorbent material. Typically, PSA is a cyclic process and requires at least two beds for continuous (as opposed to batch) operation. Examples of suitable adsorbent materials that may be used in adsorbent beds are activated carbon and zeolites, especially 5 Å (5 angstrom) zeolites. The adsorbent material is commonly in the form of pellets and it is placed in a cylindrical pressure vessel utilizing a conventional packed-bed configuration. It is within the scope of the disclosure, however, that other suitable adsorbent material compositions, forms, and configurations may be used.

An example of a suitable chemical process for use in separation region 32 is methanation, in which a methanation catalyst is used to produce methane from carbon monoxide and carbon dioxide present in the mixed gas stream. It is within the scope of the disclosure that other chemical processes, such as partial oxidation, or water-gas shift reactions, may be used to increase the purity and/or reduce the concentration of selected impurities in the mixed gas or other product stream from the hydrogen-producing region. In FIG. 2, an example of a separation region 32 that includes a methanation region 38 is schematically illustrated. As discussed, a fuel processor and/or fuel processing system according to the present disclosure may include more than one of the same or different types of separation region. To provide a graphical example of this, FIG. 2 shows a separation region with at least one hydrogen-selective membrane and a methanation region.

It is within the scope of the present disclosure that the fuel processor does not include a separation region, but is in fluid communication with at least one separation region, such as in the fuel processing assembly, or downstream from the fuel processor and/or the fuel processing assembly. Similarly, it is within the scope of the present disclosure that the fuel processing assembly may be described as including at least one separation region, and/or that the fuel processing assembly is in fluid communication with at least one separation region that is downstream from the fuel processing assembly. By “downstream,” it is meant that a component, such as a separation region, receives a stream from a component, such as a hydrogen-producing region. In other words, the upstream component receives or produces a stream that is subsequently received by the downstream component.

The scope of the disclosure includes any suitable arrangement or configuration of the above-described regions and components. For example, vaporization region 18 may at least substantially surround at least hydrogen-producing region 28.

In FIG. 1, fuel processing assembly 11 is shown including a housing 74 in which the above-described regions are at least substantially enclosed or contained. Housing 74, which also may be referred to as a shell, enables the components of fuel processing assembly 11 to be moved as a unit. It also protects the enclosed components of fuel processing assembly 11 from damage by providing a protective enclosure and reduces the heating demand of fuel processing assembly 11 because the components may be heated as a unit and/or because the shell insulates these components to reduce heat loss therefrom.

Housing 74 may be composed of one or multiple layers and may be made of any suitable material. For example, housing 74 may be composed of any suitable metal. Additionally or alternatively, housing 74 may include or otherwise be at least partially formed from a ceramic material, such as a refractory ceramic material. Refractory ceramic materials are porous materials that are made from mechanically interlocked fibers formed from such materials as alumina, silica, zirconia and the like. A benefit of refractory ceramic materials is that they are comparatively light and inexpensive compared to multi-layer metal housings. Refractory ceramic materials also have low thermal conductivity and therefore are configured not to conduct heat from the reformer or its exhaust gases through the housing. Consider, for example, that a reformer heated to approximately 500° C. will typically require not only a multi-layer metal housing but also a coolant system (such as forced air or other fluid) to maintain the outer surface of the housing below a desired temperature, such as below 50° C. While effective, that metal housing tends to be heavy and expensive to produce, in addition to requiring a coolant system.

Unlike metal housings, however, refractory ceramic materials tend to be porous and therefore permeable to the exhaust gases from a reformer or other fuel processor. Accordingly, when the reformer or other fuel processor housed within the housing emits combustion or other exhaust gases, housing 74 may include a coating, as schematically illustrated at 76 in FIG. 1 with a dash-dot line. That coating typically is impermeable to the exhaust gases produced by the reformer (or other fuel processor). The coating is applied to at least one of the inner and outer surfaces of housing 74. Illustrative (non-exclusive examples) of suitable coatings include epoxy paints, latex coatings, RTV silicone coatings, etc.

Housing 74 may be formed through any suitable method for forming articles from refractory ceramic materials. A process that has proven effective is a vacuum forming process. In a vacuum forming process, a perforated mold is placed into a slurry of the ceramic material from which the housing is formed. A vacuum is placed on the inside of the mold and used to draw moisture from the slurry through the perforations in the mold. As this occurs, the ceramic fibers in the slurry accumulate on the outer surface of the mold. After a desired thickness of fibers has accumulated on the mold, the mold is removed from the slurry, and then the produced article is removed from the mold and dried or otherwise cured. After formation, the ceramic article can be milled, drilled, cut, or otherwise machined, if necessary, to a desired final shape. Although a vacuum forming process may be used to make standardized shapes, such as boards and cylinders, it also offers the benefit of being useful to produce more complex shapes, such as may be defined by a more complex mold and/or the final machining of the process.

Housing 74 may include one or more openings, such as to include an opening that is too small for fuel processing assembly regions or components to be removed from the compartment therethrough, but which is sufficiently large for those regions to be accessed by a user, such as for maintenance, adjustment, servicing, and/or repair. Such an opening allows the user to access one or more fuel processor regions from external housing 74 without requiring the user to disassemble housing 74. The opening may take any form, such as portals, ports, pathways, or other suitable forms. Such an opening is graphically depicted in FIG. 1 at 78.

As a further variation, housing 74 may include one or more openings that define inlets or outlets from the compartment. The inlets may be used to deliver fluids into the compartment, such as for cooling within the compartment and/or for delivery to the fuel processing assembly, as well as for communication linkages to the fuel processing assembly or compartment. For example, the communication linkages may establish communication from external housing 74 with various sensors and/or flow control devices within the compartment (including within the fuel processor). The outlets may be used to exhaust fluids from the fuel processor and/or from the compartment. An illustrative example of such an opening is graphically depicted at 80 in FIG. 1. The number and type of openings (and/or associated covers/plugs/seals) in housing 74 may vary within the scope of the disclosure.

Openings in the housing will typically include a cover or conduit associated therewith so that heat within the compartment may not freely exit housing 74 to the environment. For example, an opening that is designed as an exhaust port for gases within the compartment may be coupled to an exhaust conduit that receives these hot exhaust gases. As another example, an opening that is designed to provide selective access to the compartment, such as for removal or servicing of the fuel processing assembly, may include a cover that is designed to be selectively and repeatedly removed and replaced relative to the opening. The cover may be formed from any suitable material, including a refractory or other ceramic material, insulating and/or metallic materials. As yet a further example, an opening that is used to establish communication linkages and/or receive a fluid-flow conduit may include sealing material to prevent gases within the compartment from exiting the compartment through the opening around the communication linkage or flow conduit. A cover is graphically depicted at 82 in FIG. 1.

Housing 74 may, but does not necessarily, include insulated jacket 84, such as a solid insulating material, blanket insulating material, and/or an air-filled, gas-filled, or vacuum cavity. It is within the scope of the disclosure, however, that the fuel processing assembly may be partially or fully contained, or may not be contained in a housing or shell. When fuel processing assembly 11 includes an insulated jacket 84, the insulating material may be external the housing as schematically illustrated in FIG. 1. Alternatively, the insulating material may be internal the housing, or may be both external and internal the housing. Insulated jacket 84 may be made more easily removable as compared to housing 74 to facilitate access to the housing covers. When one or more components or regions of fuel processor 12 are external to housing 74 and insulated jacket 84, those components and regions may be provided with an insulated shroud, such as insulated shroud 44 for treatment region 24 as discussed above.

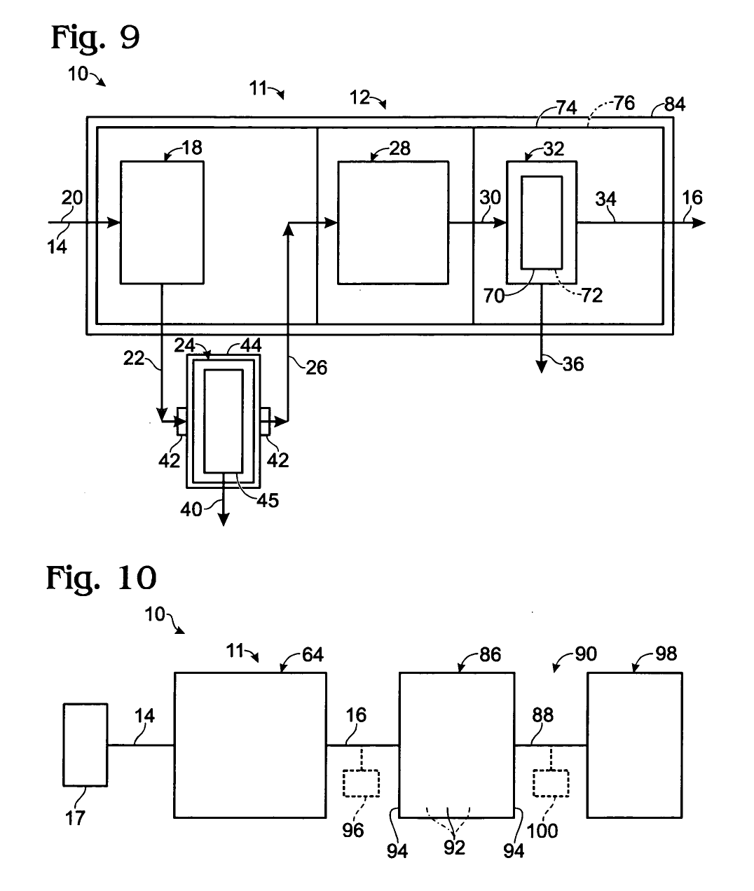

The scope of the disclosure also includes one or more of the components of fuel processing assembly 11 that may either extend beyond housing 74 or be located external at least housing 74. For example, treatment region 24 may be external housing 74 but internal insulated jacket 84, as schematically illustrated in FIG. 8. As another example, treatment region 24 may be external both housing 74 and insulated jacket 84, as schematically illustrated in FIG. 9. Additionally, the other above-described regions may be similarly positioned relative to the housing and insulated jacket in addition to, or instead of, treatment region 24. Furthermore, the scope of the disclosure includes that one or more components of fuel processing system 10, in addition to assembly 11, may be within housing 74 and/or any additional enclosures.

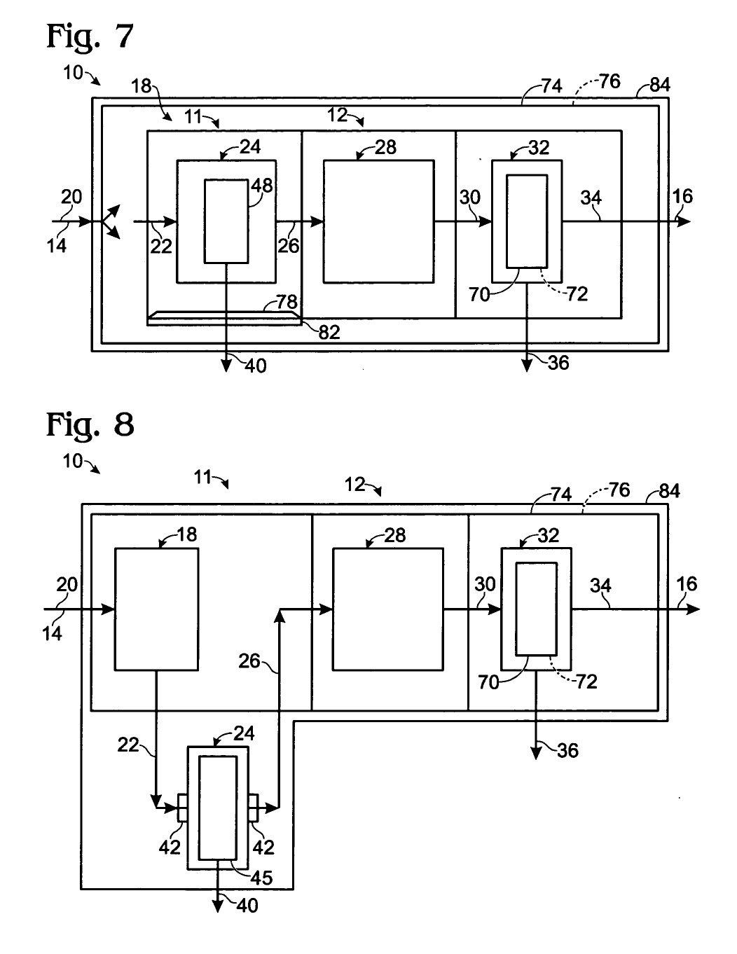

As discussed, fuel processing system 10 has been schematically illustrated in FIGS. 1-9. It is within the scope of the present disclosure that the fuel processing system will typically include various flow controllers, sensors, heat exchangers, sensors, pumps, fluid conduits, flow regulators, heating and/or cooling assemblies, and the like. For example, co-current, counter-current, mixed fluid, air-cooled, liquid-cooled and/or other heat exchangers may be used at any suitable location within the fuel processing system to selectively heat, cool and/or recover heat or cooling from various streams and/or equipment within the system. For example, in some applications, it may be desirable to selectively position heat exchangers, sensors, flow regulators, etc. at, before and/or after one or more of the varporization region, the treatment region, the hydrogen-producing region, the separation region, etc. Similarly the fuel processing system may include a control system that regulates the operation of the fuel processing system.

As schematically illustrated in FIG. 10, fuel processing assemblies according to the present disclosure may be configured to deliver at least a portion of product hydrogen stream 16 to at least one fuel cell stack 86, which produces an electric current 88 therefrom. In such a configuration, the fuel processing assembly and the fuel cell stack may be referred to as a fuel cell system 90. Although a steam reformer has been indicated at 64 in FIG. 10, it is within the scope of the disclosure that any of the fuel processors disclosed, illustrated and/or incorporated herein may be incorporated into a fuel cell system. Fuel cell stack 86 is configured to produce an electric current from the portion of product hydrogen stream 16 delivered thereto. In the illustrated embodiment, a single steam reformer 64 and a single fuel cell stack 86 are shown and described. It is within the scope of the disclosure, however, that more than one of either or both of these components may be used. It is also within the scope of the disclosure that these components have been schematically illustrated and that the fuel cell system may include additional components that are not specifically illustrated in the figures, such as feed pumps, air delivery systems, heat exchangers, heating assemblies, batteries, power management modules, and the like.

Fuel cell stack 86 contains at least one, and typically multiple, fuel cells 92 that are configured to produce an electric current 88 from the portion of the product hydrogen stream 16 delivered thereto. A fuel cell stack typically includes multiple fuel cells 92 joined together between common end plates 94, which contain fluid delivery/removal conduits (not shown). Examples of suitable fuel cells include proton exchange membrane (PEM) fuel cells and alkaline fuel cells. Fuel cell stack 86 may receive all of product hydrogen stream 16. Some or all of product hydrogen stream 16 may additionally, or alternatively, be delivered, via a suitable conduit, for use in another hydrogen-consuming process, burned for fuel or heat, or stored for later use. In dashed lines in FIG. 10, the fuel cell system is shown including an optional hydrogen storage device 96, which is configured to store at least a portion of the product hydrogen stream, such as for later delivery to fuel cell stack 86, for use as a fuel stream, etc. Illustrative examples of suitable hydrogen storage devices include pressurized tanks and hydride beds. It is within the scope of the disclosure that fuel processing systems 10 also may include a hydrogen storage device.

The electric current produced by the stack may be used to satisfy the energy demands, or applied load, of at least one associated energy-consuming device 98. Illustrative examples of devices 98 include, but should not be limited to, motor vehicles, recreational or industrial vehicles, boats or other seacraft, tools, lights or lighting assemblies, appliances (such as a household or other appliance), households or other dwellings, offices, stores or business establishments, computers, industrial equipment, signaling or communication equipment, etc. Device 98 is schematically illustrated in FIG. 10 and is meant to represent one or more devices or collection of devices that are configured to draw electric current from the fuel cell system.

In dashed lines in FIG. 10, an optional energy storage device 100 is shown. Device 100 is configured to store at least a portion of the electric current produced by the fuel cell stack and selectively use this stored current (or potential) to satisfy an applied load, such as from energy-consuming device(s) 98, the fuel processing (or fuel cell) system, etc. Examples of suitable energy storage devices include batteries, fly wheels and capacitors. As described above, devices 98 are configured to apply a load to the fuel cell system (such as to one or more of the energy storage device and the fuel cell stack), with the system being configured to provide an electric current to satisfy the applied load.

### INDUSTRIAL APPLICABILITY

Steam reformers and other fuel processing systems according to the present disclosure are applicable to the fuel processing, fuel cell and other industries in which hydrogen gas is produced, and in the case of fuel cell systems, consumed by a fuel cell stack to produce an electric current.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A fuel processing system, comprising:
a vaporization region configured to receive at least a liquid component of a feed stream and to produce therefrom a vaporized component of the feed stream;
a treatment region configured to receive and remove solids from at least the vaporized component of the feed stream; and
a hydrogen-producing region in fluid communication with the treatment region and configured to receive the feed stream and to produce therefrom a mixed gas stream containing hydrogen gas and other gases.

2. The fuel processing system of claim 1, wherein at least a substantial portion of any solids in the feed stream are formed in the vaporization region.

3. The fuel processing system of claim 1, wherein the liquid component of the feed stream is at least substantially free of the solids before being vaporized to form the vaporized component of the feed stream.

4. The fuel processing system of claim 1, wherein the solids include at least one of colloidal silica and carbon-containing solids.

5. The fuel processing system of claim 1, wherein the treatment region includes at least one filter.

6. The fuel processing system of claim 5, wherein the at least one filter includes at least one sintered filter element.

7. The fuel processing system of claim 5, wherein the at least one filter includes an outside diameter and an inside diameter, and the at least one filter is configured to receive a flow of at least the vaporized component of the feed stream from the outside diameter to the inside diameter.

8. The fuel processing system of claim 1, wherein the liquid component of the feed stream includes water.

9. The fuel processing system of claim 1, wherein the liquid component of the feed stream includes a carbon-containing feedstock.

10. The fuel processing system of claim 1, wherein the liquid component of the feed stream consists essentially of water and a carbon-containing feedstock, and further wherein the hydrogen-producing region includes at least one reforming catalyst and is adapted to produce the mixed gas stream by a steam reforming process.

11. The fuel processing system of claim 1, wherein at least substantial portions of the vaporization region, the treatment region, and the hydrogen-producing region are enclosed in a common housing.

12. The fuel processing system of claim 11, wherein at least a portion of the treatment region is configured to be accessible from external the common housing without disassembling the common housing.

13. The fuel processing system of claim 12, wherein the common housing includes at least one portal configured to provide access to at least the portion of the treatment region from external the common housing.

14. The fuel processing system of claim 11, further comprising an insulated jacket that at least substantially encloses the common housing.

15. The fuel processing system of claim 1, wherein the vaporization region and the hydrogen-producing region are at least substantially enclosed in a common housing, and further wherein the treatment region is in fluid communication with the vaporization region and the hydrogen-producing region but positioned external the common housing.

16. The fuel processing system of claim 15, wherein the treatment region includes at least one filter.

17. The fuel processing system of claim 16, wherein the at least one filter includes an internal area, and at least a portion of the internal area is configured to be accessible from external the at least one filter without disassembling the at least one filter.

18. The fuel processing system of claim 17, wherein the at least one filter includes at least one portal configured to provide access to at least the portion of the internal area from external the at least one filter.

19. The fuel processing system of claim 15, wherein the treatment region is removably coupled to the common housing by a plurality of releasable fasteners configured to permit connection and reconnection of the treatment region relative to the common housing.

20. The fuel processing system of claim 15, further comprising an insulated jacket that at least substantially encloses the common housing and the treatment region.

21. The fuel processing system of claim 15, further comprising an insulated jacket that at least substantially encloses the common housing, and an insulated shroud that at least substantially encloses the treatment region.

22. The fuel processing system of claim 1, further comprising a separation region configured to receive the mixed gas stream and to produce therefrom a hydrogen-rich stream containing at least substantially pure hydrogen gas and a byproduct stream containing at least a substantial portion of the other gases.

23. A method for treating a vaporized feed stream component of a feed stream for a fuel processor adapted to produce hydrogen gas therefrom, the method comprising:
receiving at least a vaporized feed stream component of the feed stream into a treatment region;
removing solids from at least the vaporized feed stream component of the feed stream;
delivering the feed stream to a hydrogen-producing region of the fuel processor; and
producing a stream containing hydrogen gas from the feed stream.

24. The method of claim 23, wherein the method further includes receiving a liquid component of the feed stream and vaporizing the liquid component of the feed stream to form the vaporized feed stream component.

25. The method of claim 24, wherein the vaporized feed stream component includes a greater amount of solids than the liquid feed stream component.

26. The method of claim 24, wherein at least a substantial portion of any solids in the vaporized feed stream component are formed during the vaporization of the liquid component of the feed stream.

27. The method of claim 23, wherein the solids include at least one of colloidal silica and carbon-containing solids.

28. The method of claim 23, wherein the vaporized feed stream component includes water.

29. The method of claim 23, wherein the vaporized feed stream component includes at least one carbon-containing feedstock.

30. The method of claim 23, wherein the vaporized feed stream component consists essentially of water and at least one carbon-containing feedstock.

31. The method of claim 30, wherein the producing step includes producing a mixed gas stream containing hydrogen gas and other gases via a steam reforming reaction.

32. The method of claim 23, wherein the removing step includes passing the vaporized feed stream component through a filter assembly containing at least one filter adapted to remove solids from the vaporized feed stream component.

33. A fuel processing system, comprising:
a vaporization region configured to receive at least a liquid component of a feed stream and to produce therefrom a vaporized component of the feed stream;
means for removing solids that were produced in the vaporization region from at least the vaporized component of the feed stream; and
a hydrogen-producing region in fluid communication with the means for removing solids, wherein the hydrogen-producing region is configured to receive the feed stream and to produce therefrom a stream containing hydrogen gas produced from the feed stream.

34. The fuel processing system of claim 33, wherein at least a substantial portion of any solids in the feed stream are formed in the vaporization region.

35. The fuel processing system of claim 33, wherein the solids include at least one of colloidal silica and carbon-containing solids.

36. The fuel processing system of claim 33, wherein the liquid component of the feed stream is at least substantially free of the solids before being vaporized to form at least the vaporized component of the feed stream.

37. The fuel processing system of claim 33, wherein the liquid component of the feed stream includes water.

38. The fuel processing system of claim 33, wherein the liquid component of the feed stream includes a carbon-containing feedstock.

39. The fuel processing system of claim 33, wherein the feed stream consists essentially of water and a carbon-containing feedstock.

40. The fuel processing system of claim 39, wherein the hydrogen-producing region is a steam reforming region adapted to produce the stream containing hydrogen gas via a steam reforming reaction.

41. The fuel processing system of claim 33, further comprising at least one separation region adapted to increase the concentration of hydrogen gas in the stream containing hydrogen gas.

42. A fuel processing system, comprising:
a vaporization region configured to receive at least a liquid component of a feed stream and to produce therefrom a vaporized component;
a filter assembly comprising at least one filter configured to receive and remove solids from at least the vaporized component of the feed stream;
a reforming region in fluid communication with the filter assembly and configured to receive the feed stream and to produce therefrom a mixed gas stream containing hydrogen gas and other gases; and
a housing configured to at least substantially enclose at least the vaporization region and the reforming region, and further wherein at least a portion of the filter assembly is configured to be accessible from external the housing without disassembling the housing.

43. The fuel processing system of claim 42, wherein the feed stream includes water and a carbon-containing feedstock.

44. The fuel processing system of claim 43, wherein the solids include at least one of colloidal silica and carbon-containing solids.

45. The fuel processing system of claim 42, wherein at least a substantial portion of any solids in the feed stream are formed in the vaporization region.

46. The fuel processing system of claim 42, wherein the liquid component of the feed stream is at least substantially free of the solids before being vaporized to form at least the vaporized component of the feed stream.

47. The fuel processing system of claim 42, wherein the housing encloses the filter assembly.

48. The fuel processing system of claim 42, wherein the filter assembly is positioned external the housing but in fluid communication with the vaporization region and the hydrogen-producing region.

49. The fuel processing system of claim 42, further comprising a separation region configured to receive the mixed gas stream and to separate the mixed gas stream into a product hydrogen stream containing at least substantially pure hydrogen gas and a byproduct stream containing at least a substantial portion of the other gases.

50. The fuel processing system of claim 49, wherein the separation region includes at least one of a membrane module containing at least one hydrogen-selective membrane, a pressure swing adsorption assembly, and a methanation region containing a methanation catalyst.
